(19) United States
(12) Patent Application Publication
(10) Pub. No.: US 2026/0075606 A1
(43) Pub. Date: Mar. 12, 2026

(54) METHOD AND APPARATUS FOR SELECTING MODULATION SCHEME IN WIRELESS COMMUNICATION SYSTEM

(71) Applicant: Samsung Electronics Co., Ltd., Suwon-si (KR)

(72) Inventors: Yosub PARK, Suwon-si (KR); Jinu GONG, Suwon-si (KR); Bongsung SEO, Suwon-si (KR); Min JANG, Suwon-si (KR)

(21) Appl. No.: 18/984,143

(22) Filed: Dec. 17, 2024

(30) Foreign Application Priority Data
Sep. 12, 2024 (KR) 10-2024-0124969

(51) Int. Cl. H04W 72/1263; H04L 5/00

(52) U.S. Cl. CPC H04W 72/1263; H04L 5/006

(57) ABSTRACT

The disclosure relates to a 5G or 6G communication system for supporting a higher data transmission rate. A method performed by a base station in a wireless communication system is provided. The method includes transmitting, to a terminal, a request to provide first information for capability related to selection of a modulation scheme, receiving the first information from the terminal, selecting the modulation scheme based on the first information, and transmitting second information indicating the selected modulation scheme to the terminal.

### CROSS-REFERENCE TO RELATED APPLICATION(S)

This application is based on and claims priority under 35 U.S.C. § 119 (a) of a Korean patent application number 10-2024-0124969, filed on Sep. 12, 2024, in the Korean Intellectual Property Office, the disclosure of which is incorporated by reference herein in its entirety.

### BACKGROUND

### 1. Field

The disclosure relates to a method and an apparatus for selecting a modulation scheme in a wireless communication system. More particularly, the disclosure relates to a method and an apparatus for supporting selection of modulation based on various conditions in a wireless communication system.

### 2. Description of Related Art

A review of the development of wireless communication from generation to generation shows that the development has mostly been directed to technologies for services targeting humans, such as voice-based services, multimedia services, and data services. It is expected that connected devices which are exponentially increasing after commercialization of fifth generation (5G) communication systems will be connected to communication networks. Examples of things connected to networks may include vehicles, robots, drones, home appliances, displays, smart sensors installed in various infrastructures, construction machines, factory equipment, and the like. Mobiles devices are expected to evolve into various formfactors such as augmented reality glasses, virtual reality headsets, and hologram devices. In order to provide various services by connecting hundreds of billions of devices and things in the sixth generation (6G) era, there have been ongoing efforts to develop improved 6G communication systems. For these reasons, 6G communication systems are referred to as “beyond-5G” systems.

6G communication systems, which are expected to be implemented approximately by 2030, will have a maximum transmission rate of tera (i.e., 1,000 giga)-level bps and a radio latency of 100 μsec. That is, 6G communication systems will be 50 times as fast as 5G communication systems and have the 1/10 radio latency thereof.

In order to accomplish such a high data transmission rate and an ultra-low latency, it has been considered to implement 6G communication systems in a terahertz band (for example, 95 GHz to 3 THz bands). It is expected that, due to severer path loss and atmospheric absorption in the terahertz bands than those in millimeter wave (mm Wave) bands introduced in 5G, a technology capable of securing the signal transmission distance, that is, coverage, will become more crucial. It is necessary to develop, as major technologies for securing the coverage, multiantenna transmission technologies including radio frequency (RF) elements, antennas, novel waveforms having a better coverage than orthogonal frequency-division multiplexing (OFDM), beamforming and massive multiple-input multiple-output (MIMO), full dimensional MIMO (FD-MIMO), array antennas, and large-scale antennas. In addition, there has been ongoing discussion on new technologies for improving the coverage of terahertz-band signals, such as metamaterial-based lenses and antennas, orbital angular momentum (OAM), and reconfigurable intelligent surface (RIS).

Moreover, in order to improve the frequency efficiencies and system networks, the following technologies have been developed for 6G communication systems: a full-duplex technology for enabling an uplink (user equipment (UE) transmission) and a downlink (node B (NB) transmission) to simultaneously use the same frequency resource at the same time; a network technology for utilizing satellites, high-altitude platform stations (HAPS), and the like in an integrated manner; a network structure innovation technology for supporting mobile nodes B and the like and enabling network operation optimization and automation and the like; a dynamic spectrum sharing technology though collision avoidance based on spectrum use prediction, an artificial intelligence (AI)-based communication technology for implementing system optimization by using AI from the technology design step and internalizing end-to-end AI support functions; and a next-generation distributed computing technology for implementing a service having a complexity that exceeds the limit of UE computing ability by using super-high-performance communication and computing resources (mobile edge computing (MEC), clouds, and the like). In addition, attempts have been continuously made to further enhance connectivity between devices, further optimize networks, promote software implementation of network entities, and increase the openness of wireless communication through design of new protocols to be used in 6G communication systems, development of mechanisms for implementation of hardware-based security environments and secure use of data, and development of technologies for privacy maintenance methods.

It is expected that such research and development of 6G communication systems will enable the next hyper-connected experience in new dimensions through the hyper-connectivity of 6G communication systems that covers both connections between things and connections between humans and things. Specifically, it is expected that services such as truly immersive extended reality (XR), high-fidelity mobile holograms, and digital replicas could be provided through 6G communication systems. In addition, with enhanced security and reliability, services such as remote surgery, industrial automation, and emergency response will be provided through 6G communication systems, and thus these services will be applied to various fields including industrial, medical, automobile, and home appliance fields.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below.

Accordingly, an aspect of the disclosure is to provide a method and an apparatus for selecting a modulation scheme in wireless communication systems (for example, 5G, 5G-Advanced, and 6G).

Additional aspects will be set forth in part in the description which follows and, in part, will be apparent from the description, or may be learned by practice of the presented embodiments.

In accordance with an aspect of the disclosure, a method performed by a base station in a wireless communication system is provided. The method includes transmitting, to a terminal, a request to provide first information for capability related to selection of a modulation scheme, receiving, from the terminal, the first information, selecting the modulation scheme based on the first information, and transmitting second information indicating the selected modulation scheme to the terminal.

In accordance with an aspect of the disclosure, a method performed by a terminal in a wireless communication system is provided. The method includes receiving, from a base station, a request for first information on capability related to selection of a modulation scheme, transmitting, to the base station, the first information, and receiving, from the base station, second information indicating a modulation scheme.

In an embodiment, the method further includes transmitting third information including at least one modulation scheme to the terminal through a message related to radio resource control (RRC), the at least one modulation scheme includes a non-uniform constellation, and the third information includes the selected modulation scheme.

In an embodiment, the first information includes at least one of information indicating modulation capability for uplink transmission by the terminal or information indicating modulation capability for downlink reception by the terminal.

In an embodiment, in case that the first information indicates that the terminal has modulation capability for uplink transmission, the selected modulation scheme includes a first modulation scheme for uplink transmission by the terminal, and in case that the first information indicates that the terminal has modulation capability for downlink reception, the selected modulation scheme includes a second modulation scheme for downlink reception by the terminal.

In an embodiment, the method may further include, in case that the first information indicates that the terminal has modulation capability for uplink transmission, receiving a signal to which the first modulation scheme is applied from the terminal, and in case that the first information indicates that the terminal has modulation capability for downlink reception, transmitting a signal to which the second modulation scheme is applied to the terminal.

In an embodiment, the first modulation scheme and the second modulation scheme may be selected based on at least one of a degree of calculation complexity, data computing load of a receiving node, additional gain, the number of resource blocks (RBs), and a modulation order.

In an embodiment, the second information indicating the selected modulation scheme may be transmitted through one of downlink control information (DCI), a medium access control (MAC) control element (CE), or a messaged related to radio resource control (RRC).

In an embodiment, the method further includes receiving fourth information indicating a modulation scheme preferred by the terminal from the terminal, and the selected modulation scheme is selected based on the first information and the fourth information.

In an embodiment, the selecting of the modulation scheme based on the first information may be performed based on at least one of a) a scheme in which the selecting is performed periodically, and b) a scheme in which the selecting is performed upon receiving a request from the terminal.

In accordance with an aspect of the disclosure, a base station of a wireless communication system is provided. The base station includes a transceiver, and a controller coupled with the transceiver and configured to transmit, to a terminal, a request to provide first information for capability related to selection of a modulation scheme, receive, from the terminal, the first information, select the modulation scheme based on the first information, and transmit, to the terminal, second information indicating the selected modulation scheme.

In accordance with an aspect of the disclosure, a terminal of a wireless communication system is provided. The terminal includes a transceiver, and a controller coupled with the transceiver and configured to receive, from a base station, a request for first information for capability related to selection of a modulation scheme, transmit, to the base station, the first information, and receive, from the base station, second information indicating a modulation scheme.

A method and an apparatus according to various embodiments of the disclosure may provide an effective signaling operation for selecting a modulation scheme in a wireless communication system.

Specifically, according to various embodiments of the disclosure, a uniform constellation (or modulation scheme) or high-order non-uniform constellation may be selected based on a given communication environment such that data can be transmitted/received effectively.

Other aspects, advantages, and salient features of the disclosure will become apparent to those skilled in the art from the following detailed description, which, by taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a wireless communication system according to an embodiment of the disclosure;

FIG. 2 illustrates the structure of a UE according to an embodiment of the disclosure;

FIG. 3 illustrates the structure of a base station (or network entity) according to an embodiment of the disclosure;

FIG. 4 illustrates an example of uniform constellation according to an embodiment of the disclosure;

FIG. 5 illustrates an example of non-uniform constellation according to an embodiment of the disclosure;

FIG. 6 illustrates operations of a UE and a base station for selecting a modulation scheme according to an embodiment of the disclosure;

FIG. 7 illustrates operations of a UE and a base station for selecting a modulation scheme according to an embodiment of the disclosure;

FIG. 8 illustrates operations of a UE and a base station for selecting a modulation scheme according to an embodiment of the disclosure;

FIG. 9 is a flowchart illustrating a method for selecting a modulation scheme according to an embodiment of the disclosure;

FIG. 10 illustrates an example of configuration information including candidate modulation schemes according to an embodiment of the disclosure;

FIG. 11 illustrates an example of values corresponding to the number of resource blocks (RBs) and a candidate modulation scheme (k=0 to 3) according to an embodiment of the disclosure;

FIG. 12 illustrates an example of values corresponding to a modulation order and a candidate modulation scheme according to an embodiment of the disclosure;

FIG. 13 illustrates values produced to select one of candidate modulation schemes according to an embodiment of the disclosure;

FIG. 14 illustrates operations of a UE and a base station for selecting a modulation scheme according to an embodiment of the disclosure;

FIG. 15 illustrates operations of a UE and a base station for selecting a modulation scheme according to an embodiment of the disclosure;

FIG. 16 illustrates modulation schemes corresponding to the number of resource blocks according to an embodiment of the disclosure;

FIG. 17 illustrates operations of a UE and a base station for selecting a modulation scheme according to an embodiment of the disclosure; and

FIG. 18 illustrates modulation schemes corresponding to a modulation order according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Various embodiments of the disclosure may solve the above-described problems and/or drawbacks, and provide advantages as described below. An aspect of the disclosure may provide a network entity (or node) and a communication method thereof in a wireless communication system.

The terms used herein, including technical and scientific terms, may have the same meaning as those commonly understood by a person skilled in the art to which the disclosure pertains. Such terms as those defined in a generally used dictionary may be interpreted to have the meanings equal to the contextual meanings in the relevant field of art, and are not to be interpreted to have ideal or excessively formal meanings unless clearly defined in the disclosure. In some cases, even the term defined in the disclosure should not be interpreted to exclude various embodiments of the disclosure.

Hereinafter, various embodiments of the disclosure will be described based on an approach of hardware. However, various embodiments of the disclosure include a technology that uses both hardware and software, and thus the various embodiments of the disclosure may not exclude the perspective of software.

Furthermore, various embodiments of the disclosure will be described using terms employed in some communication standards (e.g., the 3rd generation partnership project (3GPP)), but they are for illustrative purposes only. Various embodiments of the disclosure may be easily applied to other communication systems through modifications.

Hereinafter, various embodiments of the disclosure will be described.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

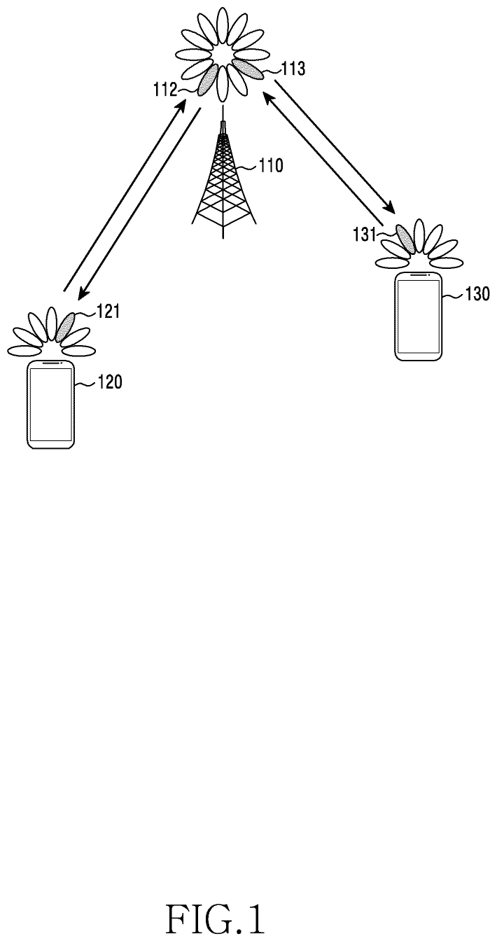

FIG. 1 illustrates a wireless communication system according to an embodiment of the disclosure.

FIG. 1 illustrates an example of a base station 110, a first UE 120, and/or a second UE 130 as a part of nodes that use a radio channel in a wireless communication system. Although FIG. 1 illustrates only one base station, the same is only an example. The wireless communication system in FIG. 1 may further include base stations identical or similar to the base station 110.

The base station 110 is a network infrastructure configured to provide wireless connection to the first UE 120 and the second UE 130. The base station 110 has a coverage defined as a predetermined geographical region based on the distance to which signals can be transmitted. The base station 110 may be also be referred to as “access point (AP)”, “evolved Node B (eNB)”, “next-generation node B (gNB)”, “5th generation node (5G node)”, “wireless point”, “transmission/reception point (TRP)”, or other terms having equivalent technical meanings, in addition to “base station”.

Each of the first UE 120 and the second UE 130 refers to a device used by a user to perform communication with the base station 110 through a radio channel. At least one of the first UE 120 or the second UE 130 may be operated without the user's intervention. For example, at least one of the first UE 120 or the second UE 130 may be a device configured to perform machine type communication (MTC) without being carried by the user. Each of the first UE 120 and the second UE 130 may also be referred to as “terminal”, “mobile station”, “subscriber station”, “customer premises equipment (CPE)”, “remote terminal”, “wireless terminal”, “electronic device”, “user device”, or other terms having equivalent technical meanings, in addition to “user equipment (UE)”.

The base station 110, the first UE 120, and the second UE 130 may transmit and/or receive radio signals in mmWave bands (for example, 28 GHz, 30 GHZ, 38 GHz, and 60 GHz). The base station 110, the first UE 120, and/or the second UE 130 may perform beamforming to improve channel gain.

The beamforming may include transmission beamforming and/or reception beamforming. That is, the base station 110, the first UE 120, and/or the second UE 130 may assign directivity to transmitted or received signals. In order to assign directivity to received signals, the base station 110 and/or the first UE 120 and the second UE 130 may select serving beams 112, 113, 121, and 131 through a beam search or beam management procedure. After the serving beams 112, 113, 121, and 131 are selected, subsequent communication may be performed through resources having a quasi co-located (QCL) relation with resources used to transmit the serving beams 112, 113, 121, and 131.

Each of the base station 110, the first UE 120, and the second UE 130 in the disclosure may be a transmitting apparatus, a transmitting node, a receiving apparatus, and/or a receiving node. For example, the base station 110 may transmit radio frequency (RF) signals to the first UE 120. The base station 110 may receive RF signals from the first UE 120. As another example, the first UE 120 may transmit RF signals to the base station 110 or the second UE 130. The first UE 120 may receive RF signals from the base station 110 or the second UE 130.

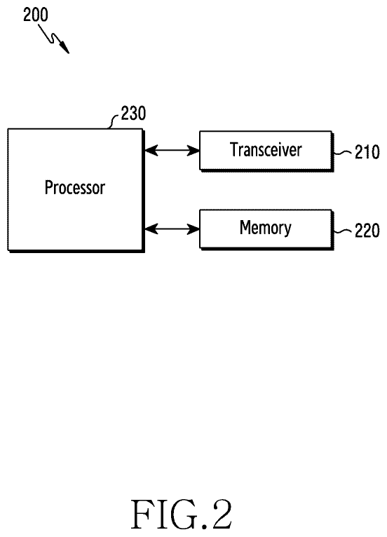

FIG. 2 illustrates the structure of a UE according to an embodiment of the disclosure.

Referring to FIG. 2, the UE 200 according to embodiments may include a transceiver 210, memory 220, and/or a processor 230. Although it is assumed in the description of the disclosure that the UE 200 includes a transceiver 210, memory 220, and/or a processor 230, the same is only an example. For example, the UE 200 may further include components other than the transceiver 210, the memory 220, and the processor 230.

According to embodiments, each of the transceiver 210, the memory 220, and the processor 230 may be implemented or formed as a separate chip. However, the same is only an example, and the transceiver 210, the memory 220, and/or the processor 230 may be implemented or formed as a single chip.

According to embodiments, the transceiver 210 may include at least one transmitter and/or at least one receiver. For example, the transceiver 210 may include an RF transmitter for amplifying the frequency of a transmitted signal and up-converting the same. The transceiver 210 may include an RF receiver for down-converting the frequency of a received signal and low-noise-amplifying the same.

Components of the transceiver 210 described in the disclosure are only examples, and are not limited to the RF transmitter and the RF receiver. For example, the transceiver 210 may further include a coupler for securing isolation between the RF transmitter and the RF receiver.

According to embodiments, the transceiver 210 may transmit signals to the processor 230 or receive signals therefrom. For example, the transceiver 210 may transmit or deliver RF signals received through a wireless communication channel to the processor 230. The transceiver 210 may receive RF signals from the processor 230 or have RF signals delivered therefrom.

According to embodiments, the transceiver 210 may be referred to as a UE transmitter or UE receiver.

According to embodiments, the transceiver 210 may transmit signals to a base station (for example, the base station 110 in FIG. 1) or network entity (for example, access and mobility management function (AMF) entity), or may receive signals from the base station or network entity. In embodiments, a transmitted or received signal may include a control signal and data.

According to embodiments, the memory 220 may include or store programs and data necessary for operations of the UE 200. For example, the memory 220 may be a non-transitory memory, and programs stored in the non-transitory memory may be organically coupled to a hardware component (for example, the processor 230 or transceiver 210) of the UE 200. The memory 220 may store control information or data including signals acquired by the UE 200. In embodiments, the memory 220 may include a read-only memory (ROM), a random access memory (RAM), a hard disk, a compact disc read only memory (CD-ROM), a digital versatile disc (DVD), and/or a storage medium.

According to embodiments, the processor 230 may include one processor or multiple processors. For example, the processor 230 may include a communication processor. For example, the processor 230 may include a communication processor and/or an application processor.

According to embodiments, the processor 230 may control a series of processes performed by the UE 200. For example, the transceiver 210 may receive data signals including control information transmitted by the base station or network entity. The processor 230 may process received control signals and data signals.

The term “processor” in the disclosure may be replaced with various terms denoting components configured to execute or perform operations of the UE 200. For example, the processor may be replaced with a controller or a computing circuit.

The UE 200 in the disclosure may correspond to the first UE 120 and/or the second UE 130 in FIG. 1.

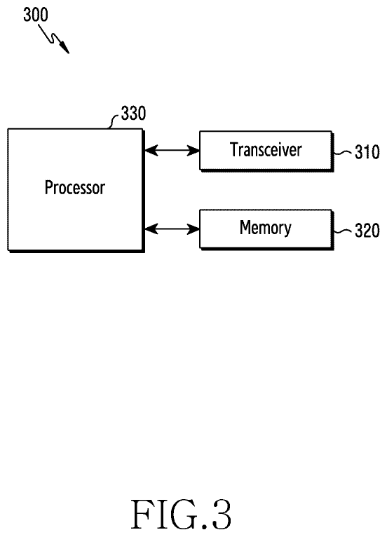

FIG. 3 illustrates the structure of a base station (or network entity) according to an embodiment of the disclosure.

Referring to FIG. 3, the base station 300 according to embodiments may include a transceiver 310, memory 320, and/or a processor 330. Although it is assumed in the description of the disclosure that the base station 300 includes a transceiver 310, memory 320, and/or a processor 330, the same is only an example. For example, the base station 300 may further include components other than the transceiver 310, the memory 320, and the processor 330. The base station 300 may represent network functions included in a core network.

According to embodiments, each of the transceiver 310, the memory 320, and the processor 330 may be implemented or formed as a separate chip. However, the same is only an example, and the transceiver 310, the memory 320, and/or the processor 330 may be implemented or formed as a single chip.

According to embodiments, the transceiver 310 may include at least one transmitter and/or at least one receiver. For example, the transceiver 310 may include an RF transmitter for amplifying the frequency of a transmitted signal and up-converting the same. The transceiver 310 may include an RF receiver for down-converting the frequency of a received signal and low-noise-amplifying the same.

Components of the transceiver 310 described in the disclosure are only examples, and are not limited to the RF transmitter and the RF receiver. For example, the transceiver 310 may further include a coupler for securing isolation between the RF transmitter and the RF receiver.

According to embodiments, the transceiver 310 may transmit signals to the processor 330 or receive signals therefrom. For example, the transceiver 310 may transmit or deliver RF signals received through a wireless communication channel to the processor 230. The transceiver 310 may receive RF signals from the processor 330 or have RF signals delivered therefrom.

According to embodiments, the transceiver 310 may be referred to as a base station transmitter or base station receiver.

According to embodiments, the transceiver 310 may transmit signals to the UE 200 or receive signals from the UE 200. In embodiments, a transmitted or received signal may include a control signal and data.

According to embodiments, the memory 320 may include programs and data necessary for operations of the base station 300. For example, the memory 320 may be a non-transitory memory, and programs stored in the non-transitory memory may be organically coupled to a hardware component (for example, the processor 330 or transceiver 310) of the base station 300. The memory 320 may store control information or data including signals acquired by the base station 300. In embodiments, the memory 320 may include a read-only memory (ROM), a random access memory (RAM), a hard disk, a CD-ROM, a DVD, and/or a storage medium.

According to embodiments, the processor 330 may include one processor or multiple processors. For example, the processor 330 may include a communication processor. For example, the processor 330 may include a communication processor and/or an application processor.

According to embodiments, the processor 330 may control a series of processes performed by the base station 300. For example, the transceiver 310 may receive data signals including control information transmitted by the UE. The processor 330 may process received control signals and data signals.

The term “processor” in the disclosure may be replaced with various terms denoting components configured to execute or perform operations of the base station 300. For example, the processor may be replaced with a controller or a computing circuit.

The base station 300 in the disclosure may correspond to the base station 110 in FIG. 1.

Devices described with reference to FIGS. 2 and 3 may correspond to devices of a transmitting node or receiving node. A UE or base station according to embodiments of the disclosure may be a transmitting node in the case of the transmitting side, and the UE or base station may be a receiving node in the case of the receiving side.

Hereinafter, a transmitting node and a receiving node may refer to the UE or base station described above with reference to FIGS. 1 to 3, respectively. When descriptions are made with regard to downlink signals, the base station and the UE may be the transmitting node and the receiving node, respectively. When descriptions are made with regard to uplink signals, the UE and the base station may be the transmitting node and the receiving node, respectively.

Meanwhile, the 3rd generation partnership project (3GPP) has adopted, as a wireless communication standard, a quadrature amplitude modulation (QAM) scheme for modulation in 4^{th} generation long-term evolution (LTE) and 5th generation new radio (NR). Modulation may refer to a process in which a bitstream that has undergone channel coding is converted to a type appropriate for transmission.

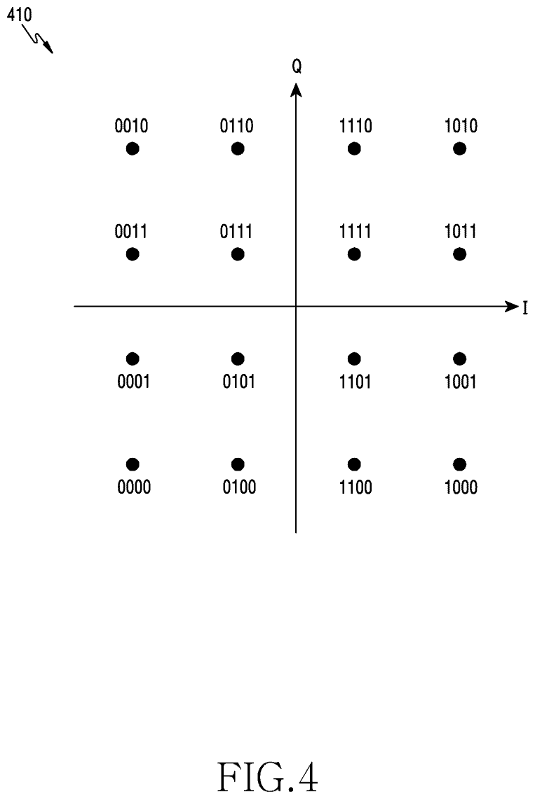

FIG. 4 illustrates an example of uniform constellation according to an embodiment of the disclosure.

FIG. 4 illustrates an example of 16-QAM which is one of QAM constellations 410 used in LTE and NR as a modulation scheme. A constellation can be described as quadrature phase shift keying (QPSK), 16-QAM, 64-QAM, or the like according to the modulation order. A uniform constellation may be designed such that respective symbols are mapped in a square type on a complex plane configured by an in-phase (I) axis and a quadratum-phase (Q) axis, and the different between respective symbols is 1 bit. A uniform constellation according to embodiments of the disclosure may refer to a constellation designed such that the interval between points (symbols) indicated on the I-Q plane is uniform.

FIG. 4 illustrates an example of uniform constellation in which four bits are mapped to each point indicated on the I-Q plane, and the points are arranged in a square type at a uniform interval.

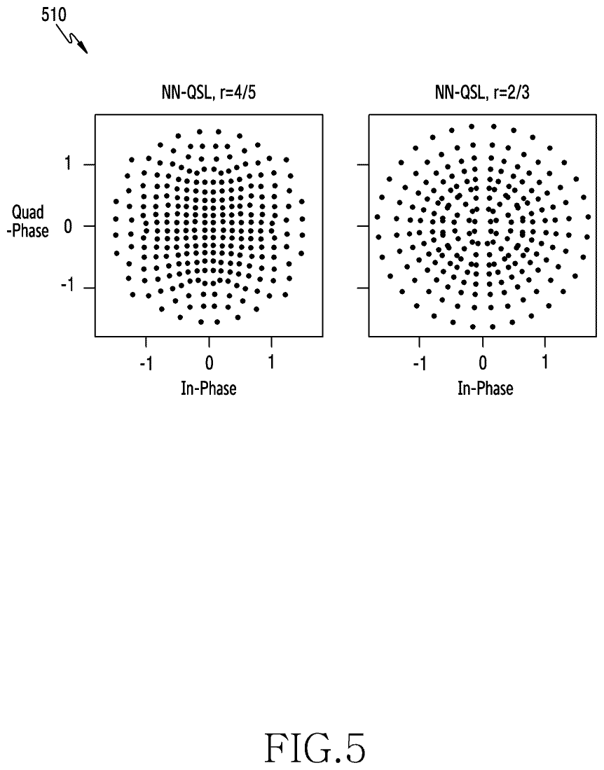

FIG. 5 illustrates an example of non-uniform constellation (NUC) according to an embodiment of the disclosure.

Specifically, FIG. 5 may illustrate a constellation 510 designed to be optimized based on artificial intelligence (AI) or machine learning (ML). It may be understood that, compared with the uniform constellation illustrated in FIG. 4, the constellation illustrated in FIG. 5 does not have a uniform interval between points (symbols) indicated on the complex plane.

As such, a high-order non-uniform constellation may be designed for optimized based on communication environments. However, existing communication methods have a problem in that it is difficult to consider non-uniform constellations according to various communication environments because modulation is performed based on a uniform constellation.

According to embodiments of the disclosure, transmission/reception operations optimized to communication conditions may be performed by selecting an appropriate modulation scheme including a non-uniform constellation under various communication conditions.

According to embodiments of the disclosure, an optimal constellation may be selected according to the number of resource blocks, the modulation order, or the channel coding rate and then used for data transmission/reception operations.

According to embodiments of the disclosure, signaling and/or operating schemes may be applied such that an appropriate constellation is used according to communication environments.

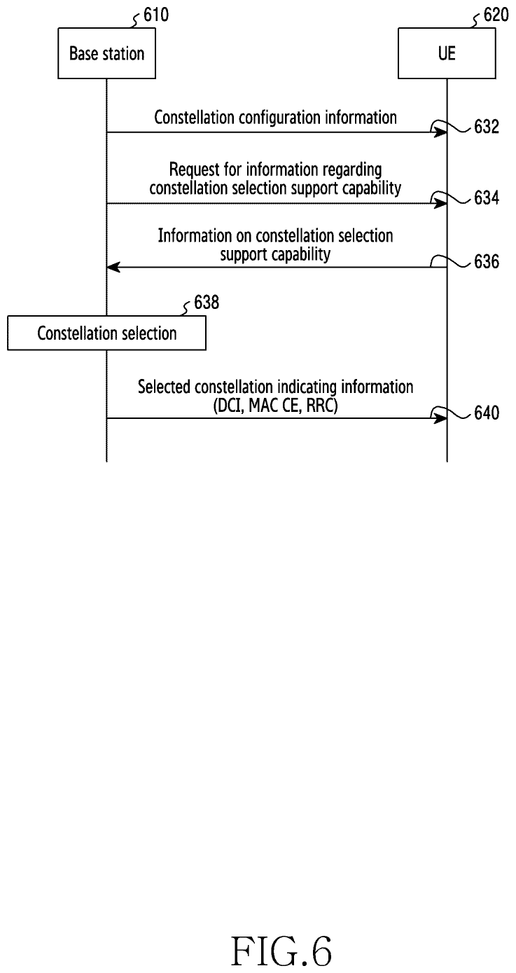

FIG. 6 illustrates operations of a UE and a base station for selecting a modulation scheme according to an embodiment of the disclosure. The base station 610 and the UE 620 in FIG. 6 may correspond to the base station and the UE in FIGS. 2 and 3.

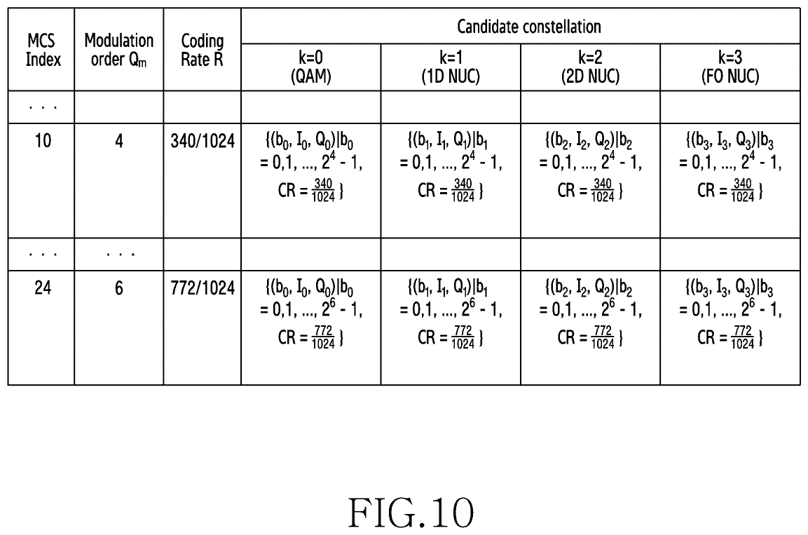

Referring to FIG. 6, in operation 632, the base station 610 transmits constellation configuration information to the UE 620. The constellation configuration information may include information for multiple candidate constellations. In addition, the constellation configuration information may include an index indicating each candidate constellation. Therefore, if the constellation configuration information is shared between the base station 610 and the UE 620, a candidate constellation may be indicated through an index between the base station 610 and the UE 620. The constellation configuration information may be configured as in the table in FIG. 10.

In an embodiment, the constellation configuration information may be transmitted between the base station and the UE through a message related to radio resource control (RRC).

In an embodiment, the constellation configuration information may be referred to as modulation scheme configuration information. The constellation configuration information may also be referred to as various other terms.

In an embodiment, the constellation configuration information may be preconfigured for the UE, and operation 632 may be omitted in this case.

In an embodiment, an update regarding the constellation configuration information may be transmitted between the base station and the UE through an RRC-related message.

In operation 634, the base station 610 may request the UE 620 to provide information for constellation selection support capability. Since the base station 610 determines whether or not to perform a constellation selecting operation according to the capability of the UE 620, the base station 610 may request the UE 620 to provide information for whether the same supports a constellation selecting operation or not.

In an embodiment, a request for information regarding constellation selection support capability may be transmitted to the UE through an RRC-related message.

In operation 636, the base station 610 may receive information for constellation selection support capability from the UE 620. The UE 620 may transmit information for constellation selection support capability to the base station 610, based on the request in operation 634. The constellation selection support capability may indicate whether the UE can apply a selected constellation or not when performing uplink transmission, and whether the UE can process signals based on the selected constellation or not when performing downlink reception. That is, the information for constellation selection support capability may include the UE's capability to apply a constellation for data transmission and the UE's capability to apply a constellation for reception.

In an embodiment, it may be indicated by “enabled” or “disabled” whether the UE can apply a selected constellation or not when performing uplink transmission, and it may be indicated by “enabled” or “disabled” whether the UE can process signals based on the selected constellation or not when performing downlink reception.

In an embodiment, information on constellation selection support capability may be transmitted to the base station through an RRC-related message.

In operation 638, the base station 610 may select a constellation, based on the UE's capability received in operation 636. For example, in case that the UE 620 is enabled to apply a constellation when performing uplink transmission, the base station 610 may select a constellation to be applied when the UE 620 performs uplink transmission. Likewise, in case that the UE 620 is enabled to apply a constellation when performing downlink reception, the base station 610 may select a constellation to be applied for data processing when the UE 620 performs downlink reception.

In descriptions of embodiments of the disclosure, a constellation may be referred to as a modulation scheme.

In operation 640, the base station 610 may transmit information indicating the constellation selected in operation 638 to the UE 620. The selected constellation may be indicated to the UE 620 by an index based on the constellation configuration information shared between the base station 610 and the UE 620 in operation 632.

In an embodiment, according to capability of the UE 620, the base station 610 may indicate a constellation for the UE's transmission and/or constellation for the UE's reception. For example, in case that the UE 620 has only capability to support constellation selection with regard to downlink reception, the base station 610 may indicate only a constellation to be applied when the UE 620 performs downlink reception and processing to the UE 620.

In an embodiment, information indicating a constellation may be transferred through downlink control information (DCI), a medium access control (MAC) control element (CE), or a message related to radio resource control (RRC).

In an embodiment, operations 638 and 640 may be repeated periodically, repeated aperiodically based on the UE's request, or operated in a semi-static or static manner. As an example, the constellation selecting operation may be performed at a cycle of 10 ms, 100 ms, or 1000 ms. Such a selection cycle may be preconfigured or transferred by the base station's upper layer.

In an embodiment, the operation of selecting an optimal constellation may be performed based on an event. For example, the constellation selecting operation may be performed if one of the following conditions is satisfied: 1) a condition for a change in modulation coding scheme (MCS) for the UE, and 2) a condition requested by the UE. With regard to condition 2), the UE may request to the base station to perform an optimal constellation selecting operation through uplink control information (UCI) or PUSCH if a change in the quality of a signal (for example, RSRP, RSRQ, RSSI, or the like) received from the base station is equal to/larger than a specific value. That is, the UE may request to the base station to perform an optimal constellation selecting operation, based on the quality of a received signal, and the base station may perform a constellation selecting operation, based on the request of the UE.

In an embodiment, the quality of a received signal may include at least one of reference signal received power (RSRP), reference signal received quality (RSRQ), received signal strength indicator (RSSI), signal to interference noise ratio (SINR), or channel quality indicator (COI).

In an embodiment, the base station may indicate a selected constellation to the UE through a medium access control (MAC) control element (CE), and may instruct the UE whether to activate or deactivate application of the indicated constellation through DCI.

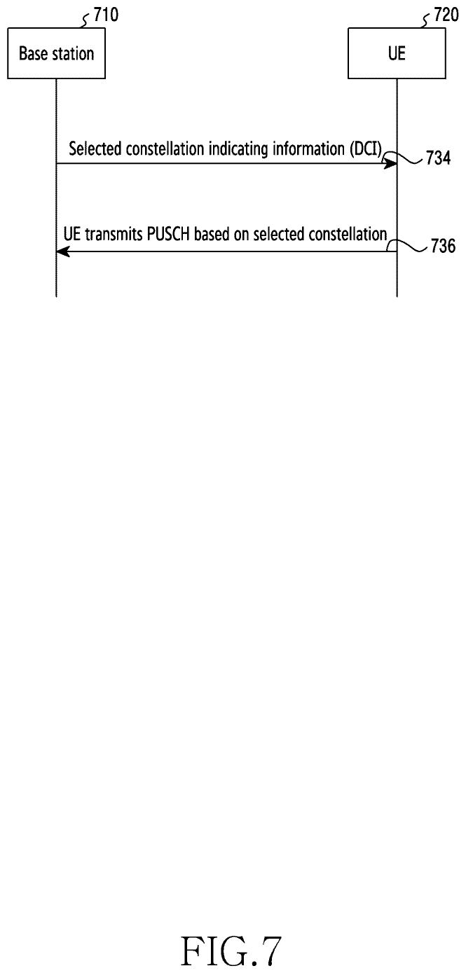

FIG. 7 illustrates operations of a UE and a base station for selecting a modulation scheme according to an embodiment of the disclosure. The base station 710 and the UE 720 in FIG. 7 may correspond to the base station 610 and the UE 620 in FIG. 6.

Referring to FIG. 7, in operation 734, the base station 710 transmits information indicating a selected constellation to the UE 720. Operation 734 in FIG. 7 may correspond to operation 640 in FIG. 6. The information indicating a selected constellation may indicate a constellation which may be applied for the UE's uplink transmission. Therefore, in operation 736, the UE 720 may modulate data, based on the indicated constellation, and may transmit modulated signals to the base station. For example, the UE 720 may transmit a physical uplink shared channel (PUSCH) to the base station, based on a constellation indicated by the base station 710.

In an embodiment, the information indicating a selected constellation may be transmitted through DCI.

In an embodiment, operation 736 may be applied for a specific time. For example, the UE may modulate data, based on the indicated constellation, and may transmit modulated signals to the base station for a specific time. The specific time may be configured for the UE through RRC during the UE's initial access, may be updated through RRC, or may be preconfigured for the UE.

In an embodiment, the indicated constellation may be used until another constellation is indicated. That is, the UE may modulate data to be transmitted, based on the previously indicated constellation until another constellation is indicated.

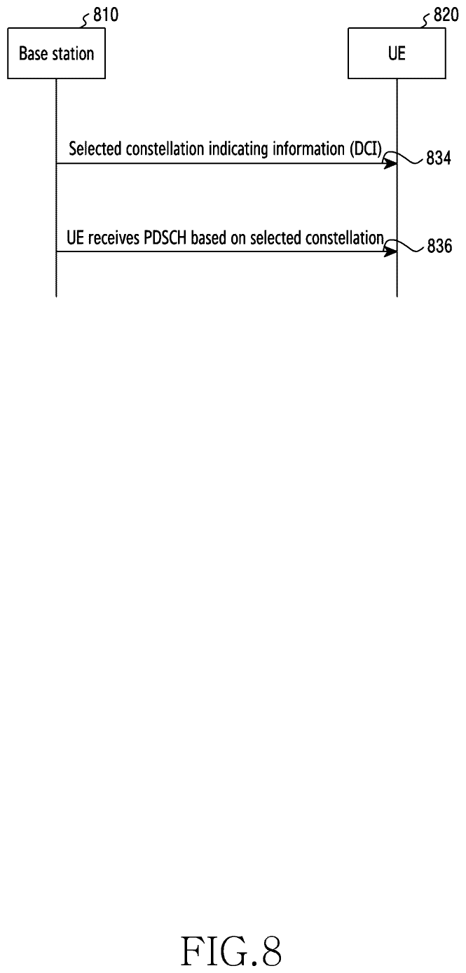

FIG. 8 illustrates operations of a UE and a base station for selecting a modulation scheme according to an embodiment of the disclosure. The base station 810 and the UE 820 in FIG. 8 may correspond to the base station 610 and the UE 620 in FIG. 6.

Referring to FIG. 8, in operation 834, the base station 810 transmits information indicating a selected constellation to the UE 820. Operation 834 in FIG. 8 may correspond to operation 640 in FIG. 6. The information indicating a selected constellation may indicate a constellation which may be applied for the UE's downlink reception. Therefore, in operation 836, the base station 810 may modulate data, based on the selected constellation, and may transmit modulated signals to the UE 820. For example, the base station 810 may transmit a physical downlink shared channel (PDSCH) to the UE 820, based on a selected constellation. The UE 820 may receive the PDSCH and may process received signals, based on the selected constellation.

In an embodiment, the information indicating a selected constellation may be transmitted through DCI.

In an embodiment, operation 836 may be applied for a specific time. For example, the UE may process signals received from the base station, based on the indicated constellation, for a specific time. The specific time may be configured for the UE through RRC during the UE's initial access, may be updated through RRC, or may be preconfigured for the UE.

In an embodiment, the indicated constellation may be used until another constellation is indicated. That is, the UE may process received signals, based on the previously indicated constellation until another constellation is indicated by the base station.

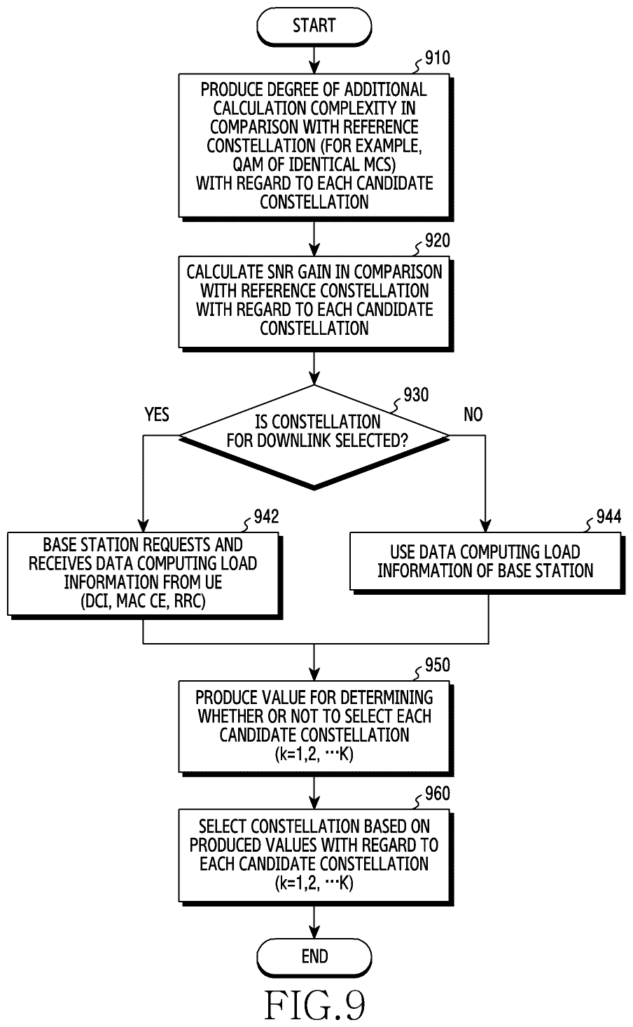

FIG. 9 is a flowchart illustrating a method for selecting a modulation scheme according to an embodiment of the disclosure. Specifically, FIG. 9 may illustrate a process of selecting one of multiple candidate constellations. FIG. 9 may correspond to operation 638 in FIG. 6.

Referring to FIG. 9, in operation 910, the degree of calculation complexity is calculated with regard to each candidate constellation in comparison with a reference constellation. The candidate constellation corresponds to one of candidate constellations included in the constellation configuration information shared between the base station and the UE in operation 632 in FIG. 6. The reference constellation is used for comparison in order to determine whether or not to apply the candidate constellation. For example, the reference constellation may be a QAM constellation of the same modulation coding scheme (MCS). The degree of calculation complexity may correspond to computation which is added, in comparison with the reference constellation, to use the candidate constellation after a signal is received by the receiving node. The degree of calculation complexity may be calculated by the number of FLOPs necessary for calculation, the execution time, and the like. Signals modulated based on a non-uniform constellation increase the degree of calculation complexity, compared with a uniform constellation, in the process in which the receiving node receives the signals and calculates the log-likelihood ratio (LLR), and such an increased in the degree of calculation complexity may thus be considered when selecting a candidate constellation.

In operation 920, signal-to-noise (SNR) gain which may be additionally obtainable may be calculated with regard to each candidate constellation in comparison with a reference constellation. For example, the SNR gain may be calculated at a target performance point, compared with QAM of the same MCS, with regard to a candidate constellation. The target performance point may be a point, the block error rate (BLER) value of which is 10%. A high level of SNR gain of a candidate constellation may be advantageous for communication, although the degree of calculation complexity is increased, and such characteristics may thus be considered when selecting a candidate constellation. Therefore, additional SNR gain may be calculated with regard to each candidate constellation in comparison with a reference constellation.

In operation 930, it may be identified whether a constellation for the downlink is selected or not. In the case of selecting a constellation for the downlink, information on the current computing load of the receiving node (for example, the UE) may be requested and received in operation 942. For example, the base station may request the UE to provide information on the computing load of the UE through signaling such as DCI, MAC CE, or RRC. The UE may select information indicating the computing load (for example, an index indicating the degree of computing load), based on the current computing load, and transmit the same to the base station. Information indicating the computing load may be determined based on short-term and long-term availability values of the CPU, GPU, and memory. The UE may transmit information indicating the computing load to the base station through signaling such as uplink control indication (UCI), MAC CE, or RRC.

In the case of selecting a constellation for the uplink, information on the current computing load of the receiving node (for example, the base station) may be produced in operation 944. For example, the base station may select computing load information by using internal information (short-term and long-term availability values of the CPU, GPU, or memory).

In operation 950, an evaluation value for determining whether or not to select each candidate constellation (for example, k=1, 2, 3, . . . , K) may be produced. The evaluation value for determining whether or not to select each candidate constellation may be calculated based on the degree of calculation complexity acquired in operation 910, the additional SNR gain acquired in operation 920, and the receiving node's computing load information acquired in operation 942 or 944.

In an embodiment, the evaluation value for determining whether or not to select a candidate constellation may be calculated based on the number of resource blocks (RBs) and/or the modulation order.

In an embodiment, the evaluation value for determining whether or not to select a candidate constellation may be calculated by Equation 1:

$$f ( A C {C}_{k} , CL , {G}_{k} ) = \text{} - α \times AC {C}_{k} - β \times C L + γ \times {G}_{k} + L U {T}_{k , RB} + LU {T}_{k , MO} \qquad [ Equation 1 ]$$

ACC_k refers to the degree of additional calculation complexity of a candidate constellation in comparison with a reference constellation. The lower the degree of calculation complexity, the higher possibility that the candidate constellation will be selected. That is, the evaluation value for the candidate constellation may be higher. α refers to a weight determined in consideration of the degree of importance of the corresponding variable, and is larger than or equal to 0.

CL refers to the computing load at the receiving node. The computing load of the receiving node may be numerical expression of the usage of the memory, CPU, or GPU. The lower the computing load of the receiving node, the higher possibility that the candidate constellation will be selected. That is, the evaluation value for the candidate constellation may be higher. β refers to a weight determined in consideration of the degree of importance of the corresponding variable, and is larger than or equal to 0.

G_k refers to SNR gain expected through use of a candidate constellation. The larger the obtainable gain in comparison with a reference constellation, the higher possibility that the candidate constellation will be selected. That is, the evaluation value for the candidate constellation may be higher. γ refers to a weight determined in consideration of the degree of importance of the corresponding variable, and is larger than or equal to 0.

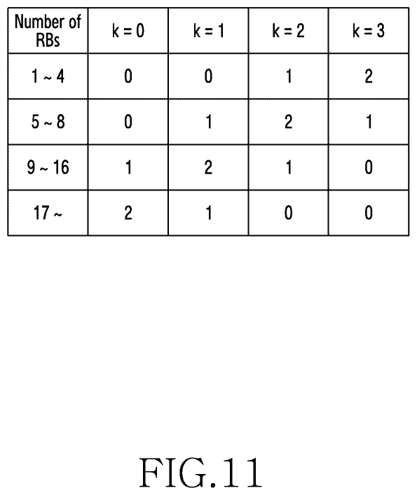

LUT_k, RB refers to a value corresponding to the number of resource blocks (RBs) assigned for uplink or downlink transmission/reception. LUT_k, RB may be designed to correspond to various values according to the candidate constellation and the number of RBs. In an embodiment (refer to FIG. 11), the smaller the number of RBs, the more advantageous it may be designed to select 2D-NUC or fully optimized (FO)-NUC. That is, the smaller the number of RBs, the larger value may correspond to the candidate constellation which is a high-order non-uniform constellation in comparison with other candidate constellations. On the other hand, the larger the number of RBs, the larger value may correspond to the reference constellation in comparison with other candidate constellations.

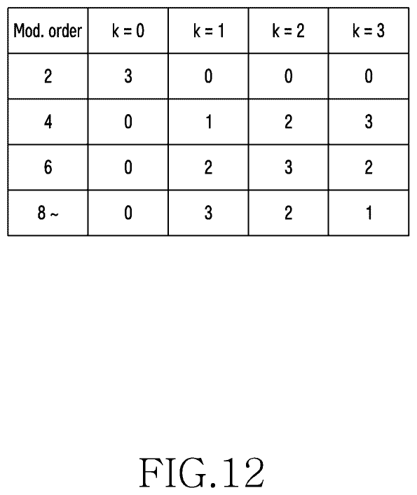

LUT_k, MO refers to a value corresponding to the modulation coding scheme (MCS) or modulation order. LUT_k, MO may be designed to correspond to various values according to the modulation order and candidate constellation. In an embodiment (refer to FIG. 12), in case that the MCS is QPSK, the same may be designed such that QAN is selected.

In an embodiment, the evaluation value for determining whether or not to select a candidate constellation may be calculated based on at least one of the degree of additional calculation complexity in comparison with the reference constellation, the computing load of the receiving node, the SNR gain, the number of RBs, and/or the modulation order. [Equation 1] described above is an example, and the evaluation value for selecting a candidate constellation may be calculated based on all or some of the variables included in [Equation 1].

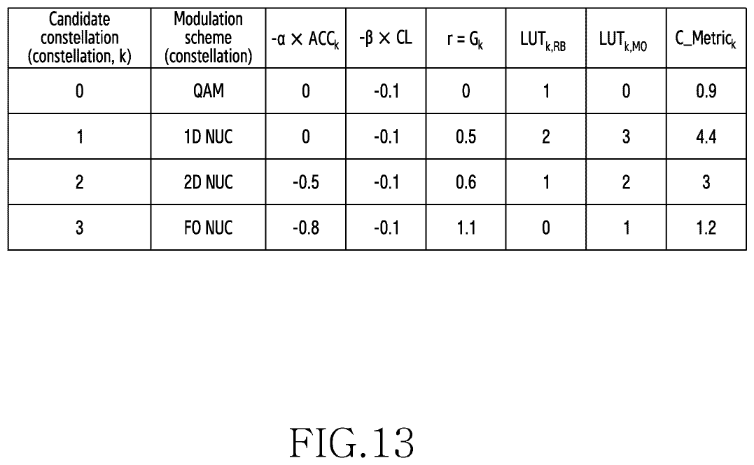

In operation 960, a constellation may be selected based on an evaluation value calculated so as to correspond to each candidate constellation. For example, a candidate constellation having the highest evaluation value may be selected by comparing evaluation values calculated with regard to respective candidate constellations according to [Equation 1] (refer to FIG. 13).

In an embodiment, the constellation selecting method in FIG. 9 may be performed by the base station or the UE.

FIG. 10 illustrates an example of configuration information including information for candidate modulation schemes according to an embodiment of the disclosure.

The table illustrated in FIG. 10 may correspond to the modulation scheme configuration information or constellation configuration information in FIG. 6.

FIG. 10 illustrates a table including a column indicating modulation coding scheme (MCS) indices, a column indicating modulation orders, and a column indicating coding rates. The table includes candidate constellations (k=0, 1, 2, 3) corresponding to the MCS indices, modulation orders, and coding rates. The candidate constellations may be defined based on in-phase (I) component values and quadrature (Q) component values with regard to respective points (b). For example, a candidate constellation (QAM) of k=0, the modulation order of which is 4, may have I component values and Q component values defined with regard to 16 points corresponding to b=0, 1, . . . , (2\hat{ }4)−1, and the candidate constellation may thus be expressed on the complex plane.

In an embodiment, a QAM scheme of k=0 may correspond to a reference constellation, and k=1 to k=3 may correspond to different candidate constellations, respectively. For example, candidate constellation of k=1 to k=3 may be selected based on a result of comparison with the reference constellation of k=0.

FIG. 11 illustrates an example of values corresponding to the number of resource blocks (RBs) and a candidate modulation scheme (or candidate constellation) according to an embodiment of the disclosure.

Referring to FIG. 11, in case that the number of RBs is 1 to 4, the value corresponding to a candidate constellation of k=0 is 0. In another example, in case that the number of RBs is 5 to 8, the value corresponding to a candidate constellation of k=1 is 1. A value obtained as such may be substituted for LUT_k, RB in [Equation 1] described above, thereby calculating an evaluation value for determining whether or not to select candidate constellations.

Values given in the table in FIG. 11 are examples, and may be designed such that, the smaller the number of RBs, the larger value a high-order non-uniform constellation has.

FIG. 12 illustrates an example of values corresponding to a modulation order and a candidate modulation scheme (or candidate constellation) according to an embodiment of the disclosure.

Referring to FIG. 12, in case that the modulation order is 2, the value corresponding to a candidate constellation of k=0 is 3. In another example, in case that the modulation order is 4, the value corresponding to a candidate constellation of k=1 is 1. A value obtained as such may be substituted for LUT_k, MO in [Equation 1] described above, thereby calculating an evaluation value for determining whether or not to select candidate constellations.

Values given in the table in FIG. 12 are examples, and values other than values in FIG. 12 may be applied.

FIG. 13 illustrates evaluation values produced to select one of candidate modulation schemes (or candidate constellations) according to an embodiment of the disclosure.

FIG. 13 illustrates evaluation values (refer to C_Metric_k column) calculated to select one of candidate constellations of k=0 to k=3. For example, if [Equation 1] is calculated with regard to the candidate constellation of k=1, the derived evaluation value may be 5.4. In addition, as illustrated in FIG. 13, the evaluation value derived with regard to the candidate constellation of k=0 is 0.9, the evaluation value derived with regard to the candidate constellation of k=2 is 3, and the evaluation value derived with regard to the candidate constellation of k=3 is 1.2. The candidate constellation having the highest derived evaluation value may be adopted as the modulation scheme for a transmission or reception operation.

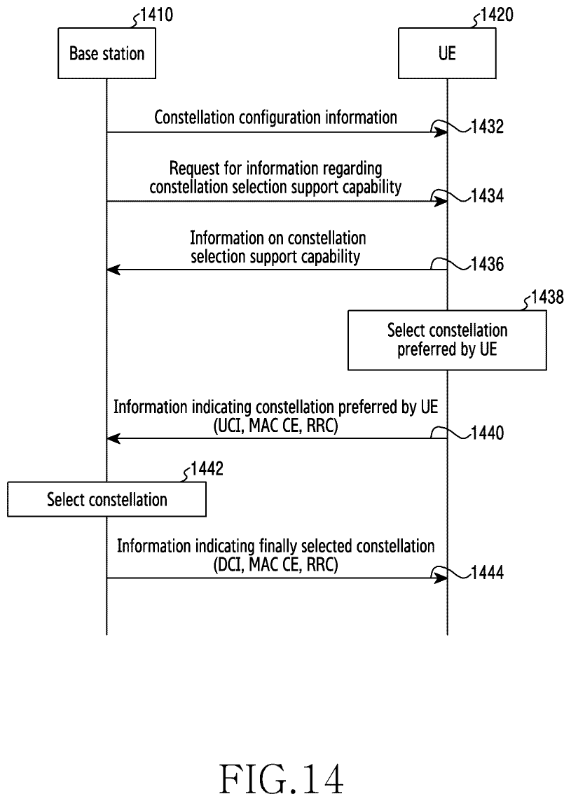

FIG. 14 illustrates operations of a UE and a base station for selecting a modulation scheme (or constellation) according to an embodiment of the disclosure. The base station 1410 and the UE 1420 in FIG. 14 may correspond to the base station and the UE in FIGS. 2 and 3.

Referring to FIG. 14, in operation 1432, the base station 1410 transmits constellation configuration information to the UE 1420. The constellation configuration information may include information for multiple candidate constellations. The configuration information including information for multiple candidate constellations may include indices which may indicate respective candidate constellations. Therefore, if the constellation configuration information is shared between the base station 1410 and the UE 1420, a candidate constellation may be indicated through an index between the base station 1410 and the UE 1420. The constellation configuration information may be configured as in the table in FIG. 10.

In an embodiment, the constellation configuration information may be transmitted between the base station and the UE through a message related to radio resource control (RRC).

In an embodiment, the constellation configuration information may be referred to as modulation scheme configuration information. The constellation configuration information may also be referred to as various other terms, and may correspond to configuration information including information for multiple candidate constellations and information for indicating the multiple candidate constellations.

In an embodiment, the constellation configuration information may be preconfigured for the UE, and operation 1432 may be omitted in this case.

In an embodiment, an update regarding the constellation configuration information may be transmitted between the base station and the UE through an RRC-related message.

In operation 1434, the base station 1410 may request the UE 1420 to provide information on constellation selection support capability. Since the base station 1410 determines whether or not to perform a constellation selecting operation according to the capability of the UE 1420, the base station 1410 may request the UE 1420 to provide information for whether the same supports a constellation selecting operation or not.

In an embodiment, a request for information on constellation selection support capability may be transmitted to the UE through an RRC-related message.

In operation 1436, the base station 1410 may receive information on constellation selection support capability from the UE 1420. The UE 1420 may transmit information on constellation selection support capability to the base station 1410, based on the request in operation 1434. The constellation selection support capability may indicate whether the UE can apply a selected constellation or not when performing uplink transmission, and whether the UE can process signals based on the selected constellation or not when performing downlink reception. That is, the information on constellation selection support capability may include the UE's capability to apply a constellation for data transmission and the UE's capability to apply a constellation for reception.

In an embodiment, it may be indicated by “enabled” or “disabled” whether the UE can apply a selected constellation or not when performing uplink transmission, and it may be indicated by “enabled” or “disabled” whether the UE can process signals based on the selected constellation or not when performing downlink reception.

In an embodiment, information on constellation selection support capability may be transmitted to the base station through an RRC-related message.

In operation 1438, the UE 1420 may select a preferred constellation, based on the UE's capability received in operation 1436. For example, in case that the UE 1420 is enabled to apply a constellation when performing uplink transmission, the UE 1420 may select a constellation for uplink transmission. Likewise, in case that the UE 1420 is enabled to apply a constellation when performing downlink reception, the UE 1420 may select a constellation for downlink reception.

In an embodiment, in case that the UE is enabled to apply a constellation for uplink transmission, the UE may request the base station to provide information indicating the current computing load in order to select a constellation for uplink transmission, and may receive information indicating the current computing load from the base station, based on the request. In addition, the UE may calculate an evaluation value for each candidate constellation by using information indicating the base station's computing load. The process in which the UE calculates an evaluation value for each candidate constellation may be identical to the process in which the base station calculates an evaluation value for each candidate constellation.

In operation 1440, the UE 1420 may transmit information indicating the preferred constellation determined in operation 1438 to the base station 1410. The constellation preferred by the UE may be indicated by an index based on the constellation configuration information shared between the base station 1410 and the UE 1420 in operation 1432.

In an embodiment, information indicating the constellation preferred by the UE may be transferred through uplink control information (UCI), a medium access control (MAC) control element (CE), or a message related to radio resource control (RRC).

In operation 1442, the base station 1410 may select a constellation, based on the UE's capability received in operation 1436. For example, in case that the UE 1420 is enabled to apply a constellation when performing uplink transmission, the base station 1410 may select a constellation to be applied when the UE 1420 performs uplink transmission. Likewise, in case that the UE 1420 is enabled to apply a constellation when performing downlink reception, the base station 1410 may select a constellation to be applied for data processing when the UE 1420 performs downlink reception. The base station 1410 may select a constellation, based on the constellation preferred by the UE in operation 1440. For example, the base station may compare the constellation preferred by the UE and the constellation preferred by base station and select one therefrom. In connection with determining which is to be determined among the constellation preferred by the UE and the constellation preferred by the base station, rules may be applied such that the base station's selection is applied preferentially, the UE's selection is applied preferentially, the latest result is applied preferentially, or the like.

In an embodiment, in case that the base station 1410 has received information indicating the constellation preferred by the UE, the calculation for selecting a constellation may be omitted. For example, the base station 1410 may select or apply a modulation scheme for transmission and reception, based on the constellation preferred by the UE. In case that the base station 1410 has received a first constellation for the UE's uplink transmission and a second constellation for the UE's downlink reception, as the constellation preferred by the UE 1420, the base station 1410 may receive data, based on the first constellation, and may transmit data, based on the second constellation.

In an embodiment, a constellation may be referred to as a modulation scheme.

In operation 1444, the base station 1410 may transmit information indicating the constellation selected in operation 1442 to the UE 1420. The selected constellation may be indicated by an index, based on the constellation configuration information shared between the base station 1410 and the UE 1420 in operation 1432.

In an embodiment, according to the capability of the UE 1420, the base station 1410 may indicate a constellation for the UE's transmission and/or a constellation for the UE's reception.

In an embodiment, information indicating a constellation may be transferred through downlink control information (DCI), a medium access control (MAC) control element (CE), or a message related to radio resource control (RRC).

In an embodiment, operations 1438 and 1444 may be repeated periodically, repeated aperiodically based on the UE's request, or operated in a semi-static or static manner.

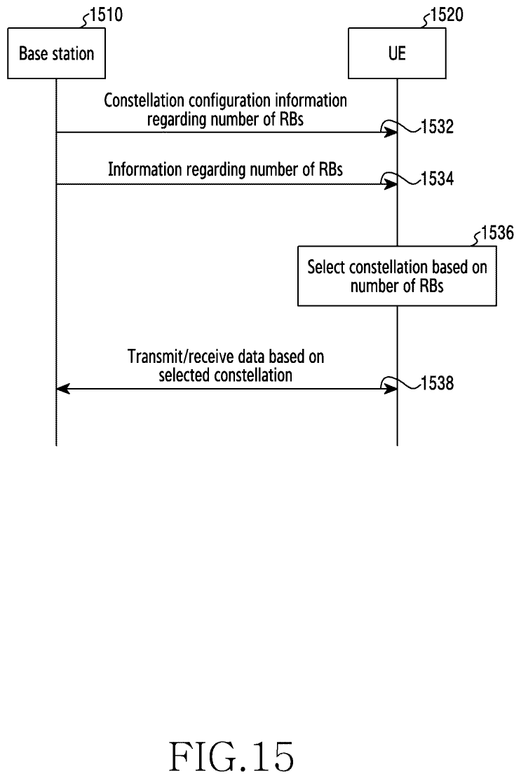

FIG. 15 illustrates operations of a UE and a base station for selecting a modulation scheme (or constellation) according to an embodiment of the disclosure. The base station 1510 and the UE 1520 in FIG. 15 may correspond to the base station and the UE in FIGS. 2 and 3. FIG. 15 relates to an embodiment in which a modulation scheme is selected based on the number of scheduled resource blocks.

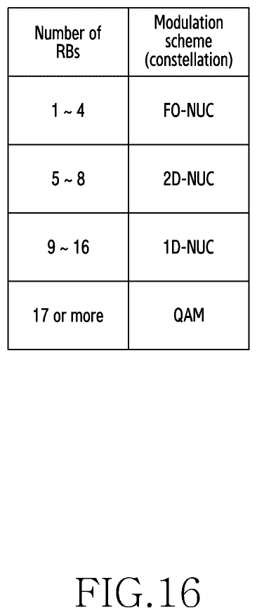

Referring to FIG. 15, in operation 1532, the base station 1510 transmits constellation configuration information which follows the number of resource blocks to the UE 1520. The table in FIG. 16 may be referred to in connection with the constellation configuration information which follows the number of resource blocks. The constellation configuration information includes information on candidate constellations corresponding to the number of resource blocks. For example, in case that the number of assigned RBs is 4 or less, the UE may perform a transmission or reception operation, based on a high-order non-uniform constellation of k=3.

In operation 1534, the base station 1510 may transmit information on the number of resource blocks (RBs) to the UE 1520. For example, information on the number of RBs may be transmitted to the UE 1520 through downlink control information (DCI) in the process in which the base station 1510 schedules resources for uplink transmission or downlink reception for the UE 1520.

In operation 1536, the UE 1520 may select a constellation, based on the number of RBs received in operation 1534. The selected constellation may include a constellation for the UE's uplink transmission and/or a constellation for the UE's downlink transmission.

In operation 1538, the base station 1510 and the UE 1520 may perform a data transmission/reception operation, based on the selected constellation. For example, in case that a first constellation is selected with regard to the UE's uplink transmission, the UE may transmit a modulated signal to the base station, based on the first constellation, and the base station may process the received signal, based on the first constellation. In addition, in case that a second constellation is selected with regard to the UE's downlink reception, the base station may transmit a modulated signal to the UE, based on the second constellation, and the UE may process the received signal, based on the second constellation.

Although the embodiment in FIG. 15 does not include an operation in which the base station requests the UE's capability information and an operation in which the base station receives the UE's capability information, corresponding operations may be applied as in the above-described embodiments.

In an embodiment, the base station may indicate, to the UE, whether or not to determine a constellation according to the number of RBs, through RRC signaling. For example, the base station may transmit RB_dependent_constellation={on, off} to the UE through RRC signaling. In case that RB_dependent_constellation=on, the UE may perform a transmission/reception operation, based on a constellation preconfigured according to the number of RBs.

FIG. 16 illustrates modulation schemes (or constellations) corresponding to the number of resource blocks according to an embodiment of the disclosure.

The table in FIG. 16 enumerates modulation schemes corresponding to the number of scheduled resource blocks. Such configuration information may correspond to the constellation configuration information transmitted/received in operation 1532 in FIG. 15.

Specifically, in case that the number of resource blocks corresponds to 1 to 4, a fully optimized non-uniform constellation (FO-NUC) may be selected; in case that the number of resource blocks corresponds to 5 to 8, a two-dimensional non-uniform constellation (2D-NUC) may be selected; in case that the number of resource blocks corresponds to 9 to 16, a one-dimensional non-uniform constellation (1D-NUC) may be selected; and in case that the number of resource blocks corresponds to 17 or larger, a QAM may be selected. That is, the UE may select a modulation scheme according to resource scheduling configured by the base station.

In an embodiment, the configuration information may be configured such that a uniform constellation is selected as the number of RBs increases.

The table in FIG. 16 is an example, and a modulation scheme corresponding to the number of scheduled resource blocks may be variously configured.

As described with reference to FIGS. 15 and 16, selecting the modulation scheme according to the number of scheduled resource blocks may be effective because the modulation scheme may be selected implicitly without an explicit instruction from the base station.

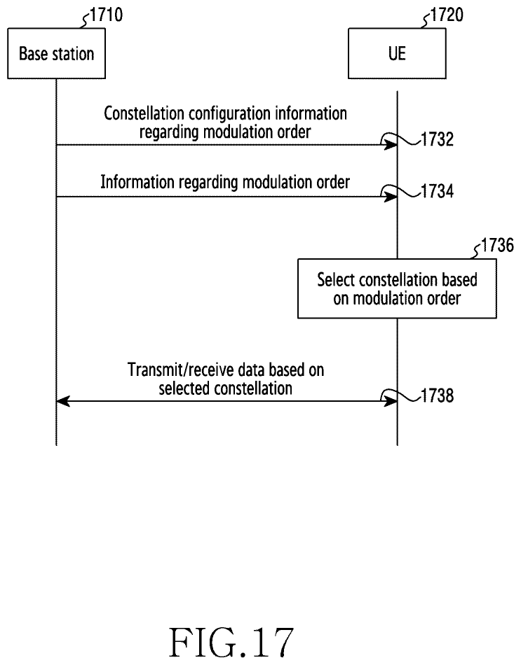

FIG. 17 illustrates operations of a UE and a base station for selecting a modulation scheme according to an embodiment of the disclosure. The base station 1710 and the UE 1720 in FIG. 17 may correspond to the base station and the UE in FIGS. 2 and 3. FIG. 17 relates to an embodiment in which a modulation scheme is selected based on the modulation order.

Referring to FIG. 17, in operation 1732, the base station 1710 transmits constellation configuration information which follows the modulation order to the UE 1720. The table in FIG. 17 may be referred to in connection with the constellation configuration information which follows the modulation order. The constellation configuration information includes information on a constellation corresponding to the modulation order.

In operation 1734, the base station 1710 may transmit information on the modulation order to the UE 1720. For example, information indicating the modulation order may be transmitted to the UE 1720 through downlink control information (DCI).

In operation 1736, the UE 1720 may select a constellation, based on the modulation order received in operation 1734. The selected constellation may include a constellation for the UE's uplink transmission and/or a constellation for the UE's downlink transmission.

In operation 1738, the base station 1710 and the UE 1720 may perform a data transmission/reception operation, based on the selected constellation. For example, in case that a first constellation is selected with regard to the UE's uplink transmission, the UE may transmit a modulated signal to the base station, based on the first constellation, and the base station may process the received signal, based on the first constellation. In addition, in case that a second constellation is selected with regard to the UE's downlink reception, the base station may transmit a modulated signal to the UE, based on the second constellation, and the UE may process the received signal, based on the second constellation.

Although the embodiment in FIG. 17 does not include an operation in which the base station requests the UE's capability information and an operation in which the base station receives the UE's capability information, corresponding operations may be applied as in the above-described embodiments.

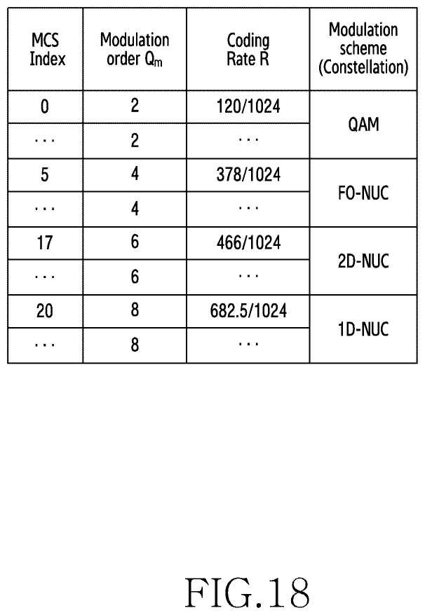

In an embodiment, the base station may indicate, to the UE, whether or not to determine a constellation according to the modulation scheme or MCS index, through RRC signaling. For example, the base station may transmit MCS_dependent_constellation={on/off} to the UE through RRC signaling. In case that MCS_dependent_constellation=on, the UE may perform a transmission/reception operation, based on a constellation corresponding to MCS information or modulation order information indicated by the base station. For example, as in FIG. 18, the UE may use QAM in case that the modulation order is 2, and the UE may use 1D-NUC in case in case that the modulation order is 8.

FIG. 18 illustrates modulation schemes (or constellations) corresponding to the modulation order according to an embodiment of the disclosure.

The table in FIG. 18 enumerates modulation schemes (or constellations) corresponding to the modulation order. Such configuration information may correspond to the constellation configuration information transmitted/received in operation 1732 in FIG. 17.

Specifically, the table in FIG. 18 may include a column indicating the index of a modulation coding scheme (MCS), a column indicating the modulation order, a column indicating the coding rate, and a column indicating the modulation scheme. Therefore, a corresponding modulation scheme may be selected by one of the MCS, modulation order, or coding rate. According to the table in FIG. 18, in case that the modulation order is 6, a two-dimensional non-uniform constellation (2D-NUC) may be selected. In another example, in case that the modulation order is 2, a QAM constellation may be selected. The UE may select and apply a modulation scheme so as to correspond to one of the MCS, modulation order, or coding rate configured by the base station.

The table in FIG. 18 is an example, and a modulation scheme corresponding to the modulation order may be variously configured.

As described with reference to FIGS. 17 and 18, selecting the modulation scheme according to the modulation order may be effective because the modulation scheme is applied implicitly without an explicit instruction from the base station.

Meanwhile, a method performed by a base station according to embodiments of the disclosure may include an operation of requesting a terminal to provide first information on capability related to selection of a modulation scheme (for example, constellation), an operation of receiving the first information from the terminal, an operation of selecting a modulation scheme, based on the first information, and an operation of transmitting second information indicating the selected modulation scheme to the terminal.

The method may further include an operation of transmitting third information including at least one modulation scheme to the terminal through a message related to radio resource control (RRC). The third information may represent constellation configuration information including information on multiple candidate constellations. The third information may include a modulation scheme of a non-uniform constellation, and may include a modulation scheme selected by the base station. Such configuration information may be preconfigured (refer to descriptions with reference to FIG. 10).

The first information may include at least one of information indicating modulation capability for uplink transmission of the terminal or information indicating modulation capability for downlink reception of the terminal. In case that the first information indicates that the terminal has modulation capability for uplink transmission, the selected modulation scheme includes a first modulation scheme for uplink transmission of the terminal, and in case that the first information indicates that the terminal has modulation capability for downlink reception, the selected modulation scheme includes a second modulation scheme for downlink reception of the terminal. In addition, in case that the first information indicates that the terminal has modulation capability for uplink transmission, the method further includes an operation of receiving a signal to which the first modulation scheme is applied from the terminal, and in case that the first information indicates that the terminal has modulation capability for downlink reception, the method further includes an operation of transmitting a signal to which the second modulation scheme is applied to the terminal (refer to descriptions with reference to FIGS. 7 and 8).

In an embodiment, the first modulation scheme and the second modulation scheme may be selected based on at least one of the degree of calculation complexity, data computing load of a receiving node, additional signal-to-noise (SNR) gain, the number of resource blocks (RBs), and a modulation order (refer to descriptions with reference to FIGS. 9 to 13).

In an embodiment, the second information indicating the modulation scheme selected by the base station may be transmitted through one of downlink control information (DCI), a medium access control (MAC) control element (CE), or a messaged related to radio resource control (RRC).

In addition, the method further includes an operation of receiving fourth information indicating a modulation scheme preferred by the terminal from the terminal, and the selected modulation scheme may be selected based on the first information and the fourth information.

In an embodiment, the operation of selecting a modulation scheme based on the first information may be performed based on at least one of a) a scheme in which the operation is performed periodically, and b) a scheme in which the operation is performed upon receiving a request from the terminal.

Although operations of a communication method according to embodiments of the disclosure have been described separately with regard to respective embodiments, operations included in respective embodiments may be combined with operations in other embodiments so as to constitute new embodiments. Therefore, it may be understood that embodiments corresponding to combinations of embodiments of the disclosure also have been described by the disclosure.

It should be appreciated that the embodiments and the terms used therein are not intended to limit the technological features set forth herein to particular embodiments and the disclosure includes various changes, equivalents, or alternatives for a corresponding embodiment. With regard to the description of the drawings, similar reference numerals may be used to designate similar or relevant elements. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. Such terms as “a first,” “a second,” “the first,” and “the second” may be used to simply distinguish a corresponding element from another, and does not limit the elements in other aspect (e.g., importance or order). If an element (e.g., a first element) is referred to, with or without the term “operatively” or “communicatively”, as “coupled with/to” or “connected with/to” another element (e.g., a second element), it means that the element may be coupled/connected with/to the other element directly (e.g., wiredly), wirelessly, or via a third element.

As used in various embodiments of the disclosure, the term “module” may include a unit implemented in hardware, software, or firmware, and may be interchangeably used with other terms, for example, “logic,” “logic block,” “component,” or “circuit”. The “module” may be a single integrated component, or a minimum unit or part thereof, adapted to perform one or more functions. For example, according to an embodiment, the “module” may be implemented in the form of an application-specific integrated circuit (ASIC).

Various embodiments as set forth herein may be implemented as software (e.g., the program) including one or more instructions that are stored in a storage medium (e.g., the internal memory or external memory) that is readable by a machine (e.g., the electronic device). For example, a processor (e.g., the processor 230) of the machine (e.g., the UE 200) may invoke at least one of the one or more instructions stored in the storage medium, and execute it. This allows the machine to be operated to perform at least one function according to the at least one instruction invoked. The one or more instructions each may include a code generated by a complier or a code executable by an interpreter. The machine-readable storage medium may be provided in the form of a non-transitory storage medium. Herein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, methods according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each element (e.g., a module or a program) of the above-described elements may include a single entity or multiple entities, and some of the multiple entities may be separately disposed in any other element. According to various embodiments, one or more of the above-described elements or operations may be omitted, or one or more other elements or operations may be added. Alternatively or additionally, a plurality of elements (e.g., modules or programs) may be integrated into a single element. In such a case, according to various embodiments, the integrated element may still perform one or more functions of each of the plurality of elements in the same or similar manner as they are performed by a corresponding one of the plurality of elements before the integration. According to various embodiments, operations performed by the module, the program, or another element may be carried out sequentially, in parallel, repeatedly, or heuristically, or one or more of the operations may be executed in a different order or omitted, or one or more other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a base station in a wireless communication system, the method comprising:
transmitting, to a terminal, a request for first information for capability related to selection of a modulation scheme;
receiving, from the terminal, the first information;
selecting the modulation scheme based on the first information; and
transmitting, to the terminal, second information indicating the selected modulation scheme.

2. The method of claim 1, further comprising:
transmitting, to the terminal, third information including at least one modulation scheme through a message related to radio resource control (RRC),
wherein the at least one modulation scheme includes a non-uniform constellation, and
wherein the third information includes the selected modulation scheme.

3. The method of claim 1, wherein the first information includes at least one of information indicating a modulation capability for an uplink transmission of the terminal or information indicating a modulation capability for a downlink reception of the terminal.

4. The method of claim 3,
wherein the selected modulation scheme includes a first modulation scheme for the uplink transmission by the terminal in case that the first information indicates that the terminal has the modulation capability for the uplink transmission, and
wherein the selected modulation scheme includes a second modulation scheme for the downlink reception by the terminal in case that the first information indicates that the terminal has the modulation capability for the downlink reception.

5. The method of claim 4, further comprising:
in case that the first information indicates that the terminal has the modulation capability for the uplink transmission, receiving, from the terminal, a signal to which the first modulation scheme is applied; and
in case that the first information indicates that the terminal has the modulation capability for the downlink reception, transmitting, to the terminal, a signal to which the second modulation scheme is applied.

6. The method of claim 4, wherein the first modulation scheme and the second modulation scheme are selected based on at least one of a degree of calculation complexity, data computing load of a receiving node, an additional signal-to-noise (SNR) gain, a number of resource blocks (RBs), or a modulation order.

7. The method of claim 1, wherein the second information indicating the selected modulation scheme is transmitted through one of downlink control information (DCI), a medium access control (MAC) control element (CE), or a message related to a radio resource control (RRC).

8. The method of claim 1, further comprising:
receiving, from the terminal, fourth information indicating a modulation scheme preferred by the terminal,
wherein the selected modulation scheme is selected based on the first information and the fourth information.

9. The method of claim 1, wherein the selecting of the modulation scheme based on the first information is performed based on at least one of a scheme in which the selecting is performed periodically, or a scheme in which the selecting is performed upon receiving a request from the terminal.

10. A method performed by a terminal in a wireless communication system, the method comprising:
receiving, from a base station, a request for first information on capability related to selection of a modulation scheme;
transmitting, to the base station, the first information; and
receiving, from the base station, second information indicating a modulation scheme.

11. The method of claim 10, further comprising:
receiving, from the base station, third information comprising at least one modulation scheme through a message related to a radio resource control (RRC),
wherein the at least one modulation scheme includes a non-uniform constellation, and
wherein the third information includes the modulation scheme indicated by the second information.

12. The method of claim 10, wherein the first information includes at least one of information indicating a modulation capability for an uplink transmission of the terminal or information indicating a modulation capability for a downlink reception of the terminal.

13. The method of claim 12,
wherein the second information includes a first modulation scheme for the uplink transmission of the terminal in case that the first information indicates that the terminal has the modulation capability for the uplink transmission, and
wherein the second information includes a second modulation scheme for the downlink reception of the terminal in case that the first information indicates that the terminal has the modulation capability for the downlink reception.

14. The method of claim 13, further comprising:
in case that the first information indicates that the terminal has the modulation capability for the uplink transmission, transmitting, to the base station, a signal to which the first modulation scheme is applied; and
in case that the first information indicates that the terminal has the modulation capability for the downlink reception, receiving, from the base station, a signal to which the second modulation scheme is applied.

15. The method of claim 13, wherein the first modulation scheme and the second modulation scheme are selected based on at least one of a degree of calculation complexity, data computing load of a receiving node, additional gain, a number of resource blocks (RBs), or a modulation order.

16. The method of claim 10, wherein the second information indicating the modulation scheme is transmitted through one of downlink control information (DCI), a medium access control (MAC) control element (CE), or a message related to radio resource control (RRC).

17. The method of claim 10, further comprising:
selecting a preferred modulation scheme; and
transmitting, to the base station, fourth information indicating the preferred modulation scheme.

18. The method of claim 17, wherein the selecting of the preferred modulation scheme is performed based on at least one of a scheme in which the selecting is performed periodically, or a scheme in which the selecting is performed upon receiving a request from the base station.

19. A base station of a wireless communication system, the base station comprising:
a transceiver; and
a controller coupled with the transceiver and configured to:
transmit, to a terminal, a request for first information for capability related to selection of a modulation scheme,
receive, from the terminal, the first information,
select the modulation scheme based on the first information, and
transmit, to the terminal, second information indicating the selected modulation scheme.

20. A terminal of a wireless communication system, the terminal comprising:
a transceiver; and
a controller coupled with the transceiver and configured to:
receive, from a base station, a request for first information for capability related to selection of a modulation scheme,
transmit, to the base station, the first information, and
receive, from the base station, second information indicating a modulation scheme.
